(19) United States
(12) Patent Application Publication
(10) Pub. No.: US 2011/0041571 A1
(43) Pub. Date: Feb. 24, 2011

(54) VEHICLE DOOR LOCKING SYSTEM

(75) Inventors: Jae Kyu LEE, Gunpo-si (KR); Byeong Sam Son, Daegu (KR)

Correspondence Address: MORGAN, LEWIS & BOCKIUS LLP (SF), One Market, Spear Street Tower, Suite 2800, San Francisco, CA, 94105, US

(73) Assignees: HYUNDAI MOTOR COMPANY, Seoul (KR); PYEONG HWA AUTOMOTIVE CO., LTD., Daegu (KR)

(21) Appl. No.: 12/621,889

(22) Filed: Nov. 19, 2009

(30) Foreign Application Priority Data
Aug. 19, 2009 (KR) 10-2009-0076922

(51) Int. Cl. E05B 65/00

(52) U.S. Cl. 70/91

(57) ABSTRACT

A vehicle door locking system, in which a push lock function is added to the door lock release lever of an existing vehicle, integrates a lock release function and a safety lock function into a single integrated lever to thereby permit the number of parts and the cost of production to be reduced. To this end, the vehicle door locking system includes a door latch assembly installed on one side of a door, an integrated lever operating the door latch assembly, and a cable connecting the integrated lever with the door latch assembly. The door is put in an open state when the integrated lever is pulled, an unlocked state when the integrated lever is in a neutral state, and a safety locked state when the integrated lever is pushed.

### CROSS-REFERENCE TO RELATED APPLICATION

The present application claims priority of Korean Patent Application Number 10-2009-0076922 filed Aug. 19, 2009, the entire contents of which application is incorporated herein for all purposes by this reference.

### BACKGROUND OF THE INVENTION

1. Field of the Invention

The present disclosure relates to a vehicle door locking system. More particularly, it relates to a vehicle door locking system, in which an inside handle is pushed to lock a door.

2. Description of Related Art

In general, the door of a vehicle is equipped with an inside handle connected with a latch on the inner side thereof so as to be able to unlock or lock the door.

FIG. 1 is a schematic perspective view illustrating a conventional vehicle door locking system.

Referring to FIG. 1, a door inside handle 10 includes a lock release lever 20 pulled to open a door, and a safety lock knob 40 installed on the same axis as the lock release lever 20 and adjusting the operation of a safety lock.

The lock release lever 20 is connected to a latch 70 via a lock release cable 30, and the safety lock knob 40 is connected to the latch 70 via a safety lock cable 50.

At this time, when the safety lock knob 40 protrudes toward the passenger compartment, the lock release lever 20 is pulled to open the door. On the other hand, when the safety lock knob 40 is pushed away from the passenger compartment, i.e. does not protrude toward the passenger compartment, the door will not open although the lock release lever 20 is pulled.

However, the door locking system facilitates the convenience of a user by installing the safety lock knob, the lock release lever, the two cables, and the latch assembly for a door locks in the vehicle door. The safety lock knob and the lock release lever are connected to and operated with the latch assembly through respective cables, so that the number of parts and the number of assembling steps are increased, which is attributed to increasing the cost of production.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

The present invention has been made in an effort to solve the above-described problems associated with the prior art. The present invention is directed toward providing a vehicle door locking system, in which a push lock function is added to an existing lock release lever, thereby integrating the function of an existing safety lock knob into a single lever to thereby permit the number of parts and the cost of production to be reduced.

In one aspect, the present invention provides a vehicle door locking system which includes a door latch assembly installed on one side of a door, an integrated lever operating the door latch assembly, and a cable connecting the integrated lever with the door latch assembly. The state of the door changes to an open state when the integrated lever is pulled, an unlocked state when the integrated lever is neutral, and a safety locked state when the integrated lever is pushed in.

According to the present invention, the vehicle door locking system has the following advantages and effects.

First, in the case of a conventional inside handle, a lock release lever and a safety lock knob are separately installed to facilitate the convenience of a passenger. On the contrary, in the case of the inventive inside handle, a push function is added to a lock release lever, thereby integrating the function of the safety lock knob. As a result, the parts associated with the function of the safety lock knob are eliminated to be able to reduce the number of parts and the cost of production.

Second, the end of a cable is coupled to a safety lock link using a ball joint, and a latch release link is rotated by a hook connected to the end of the cable, so that a lock release function and a safety lock function can be simultaneously realized using a single integrated lever.

Other aspects and other embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example a vehicle which is both gasoline- and electric-powered.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic perspective view illustrating a conventional vehicle door locking system.

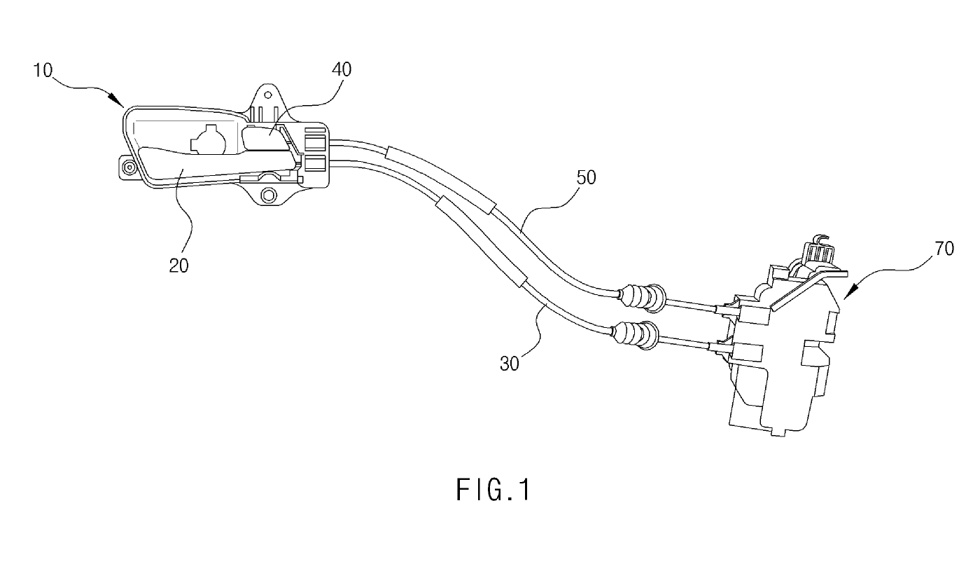

FIG. 2 is a schematic view illustrating a vehicle door locking system according to an embodiment of the present invention.

FIG. 3 illustrates the operation of each component at the time of performing the door lock operation in accordance with an embodiment of the present invention.

FIG. 4 illustrates the operation of each component at the time of performing the door unlock operation in accordance with an embodiment of the present invention.

FIG. 5 illustrates the operation of each component at the time of performing the door open operation in accordance with an embodiment of the present invention.

FIG. 6 illustrates the operation of a safety lock link at the time of performing each door operation in accordance with an embodiment of the present invention.

It should be understood that the appended drawings are not necessarily to scale and present a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

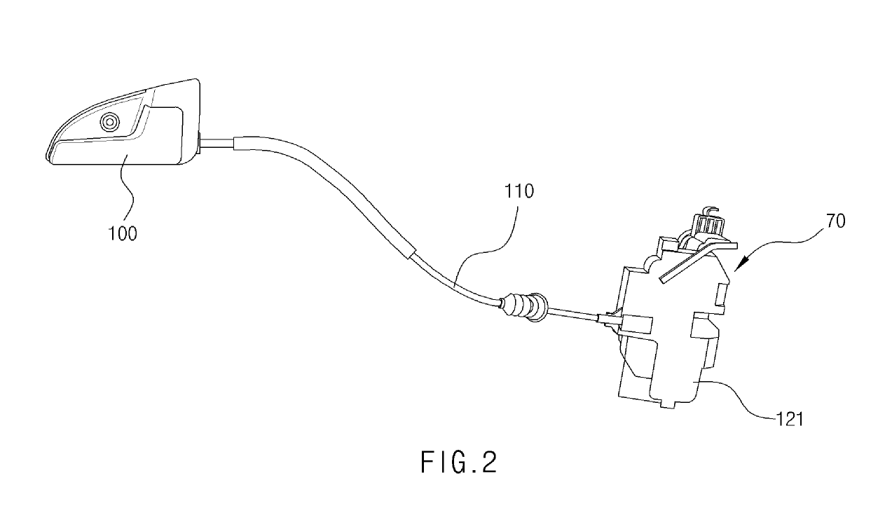

FIG. 2 is a schematic view illustrating a vehicle door locking system according to an embodiment of the present invention.

The present invention is directed to a vehicle door locking system, which adds the function of a safety lock knob to a lock release lever, instead of removing the safety lock knob installed on an existing inside handle.

An existing lock release lever for opening a door is a device which is required to perform only a pull operation, and thus uses no push operation.

However, the present invention is configured to apply a locking function to the pushing function of the lock release lever.

The vehicle door locking system according to an embodiment of the present invention includes an integrated lever 100, a cable 110, and a door latch assembly.

The integrated lever 100 operates the door latch assembly to open, unlock, or lock the door.

The integrated lever 100 makes it possible to perform pull, neutral and push operations. The push operation is added to the existing lock release lever, so that a locking function can be implemented by the existing lock release lever.

Here, the neutral operation of the integrated lever 100 refers to the state where the pull operation of the integrated lever 100 is released, i.e. the state where the integrated lever 100 is not pulled toward the passenger compartment and is not pushed away from the passenger compartment.

The integrated lever 100 is connected with the door latch assembly. Thus, when the integrated lever 100 is pulled, the door is opened. When the integrated lever 100 is released from being pulled, the door is unlocked. When the integrated lever 100 is pushed, the door is locked.

The cable 110 connects the integrated lever 100 with the door latch assembly, and thus serves to transmit the operation of the integrated lever 100 to the door latch assembly.

The door latch assembly is mounted on an inner panel of the door, and includes a housing 121, an end of the cable 110, and first to fourth links 122, 126, 127 and 125.

The housing 121 holds the end of the cable 110 and the first to fourth links 122, 126, 127 and 125, and serves to protect them from an external force.

The cable 110 is connected to a first end of the housing 121. The end of the cable 110, which is connected so as to integrally move with the cable 110, is inserted into the first end of the housing 121. The end of the cable 110 is provided with a ball end 111 having the shape of a ball.

At this time, the ball end 111 has a connecting cable 123 of a small diameter, which extends along the same axis as the cable 110. A hook 124 is attached to an end of the connecting cable 123. The hook 124 is connected with the fourth link 125, which will be described below.

The first link 122 includes a ball socket 122a formed to retain the ball end 111 of the end of the cable. Thus, the first link 122 continues to be coupled with the ball end 111 of the end of the cable 110 in locking and unlocking functions when the ball socket 122a retains the ball end 111 of the end of the cable 110, and continues to be decoupled from the ball end 111 of the end of the cable 110 in a releasing (opening) function.

The first link 122 is rotatably supported on one side of the housing 121 at one end thereof, and is rotatably hinged with one end of the second link 126 at the other end thereof. The other end of the second link 126 is connected with one end of the third link 127. The third link 127 is installed in the housing 121 so as to be movable left and right.

The second link 126 is provided with a hinge part 126a, which is hinged to an upper end of the third link 127, and a slide part 126b, which is slidably coupled to a lower portion of the third link 127, at the other end thereof.

The third link 127 is formed with a slide groove in one end thereof, so that the slide part 126b of the second link 126 can move left and right along the slide groove of the third link 127.

The fourth link 125 is rotatably installed on a lower side of the housing 121, and is provided with a hooking slot in one end thereof, so that the hook 124 is slidably coupled in the hooking slot of the fourth link 125. As the end of the cable is pulled or pushed, the fourth link 125 is rotated, so that the open or lock/unlock operation is carried out.

Further, the housing 121 is provided with a guide protrusion at an upper end thereof. The guide protrusion serves to guide the ball end 111 to be coupled to the ball socket 122a of the first link 122 when the ball end 111 of the end of the cable 110 moves up and down.

The hook 124 is coupled in the hooking slot so as to be movable up and down. Thus, the hook 124 moves toward a lower end of the hooking slot in a door locked state, and toward an upper end of the hooking slot in a door unlocked state.

An operation of the vehicle door locking system having this configuration in accordance with an embodiment of the present invention will be described below.

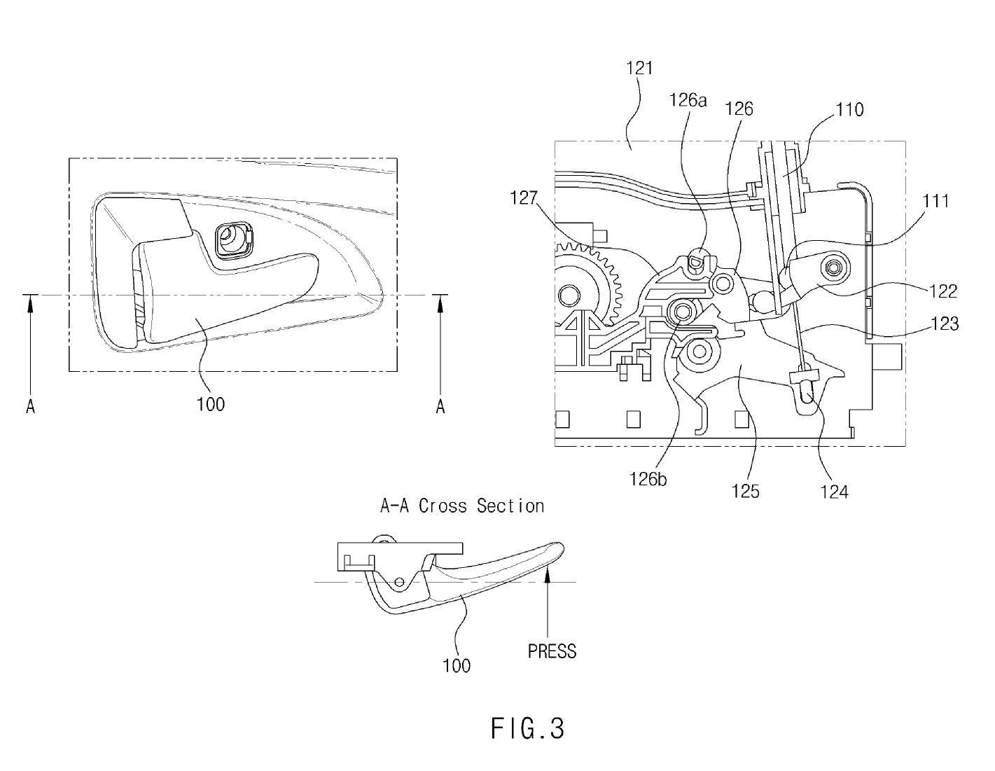

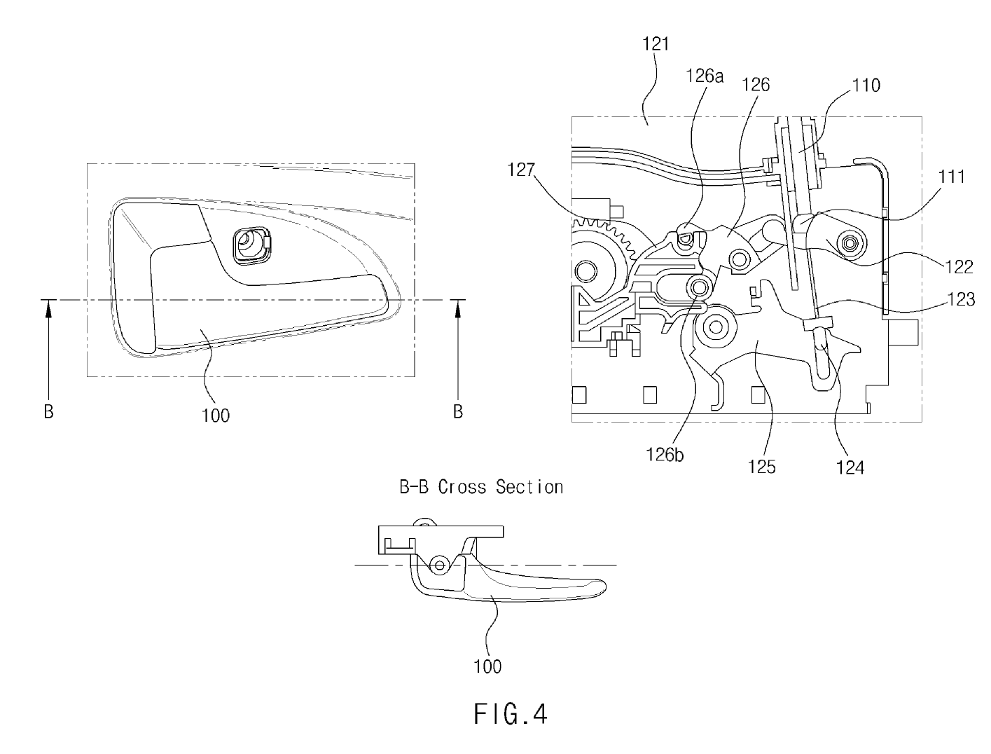

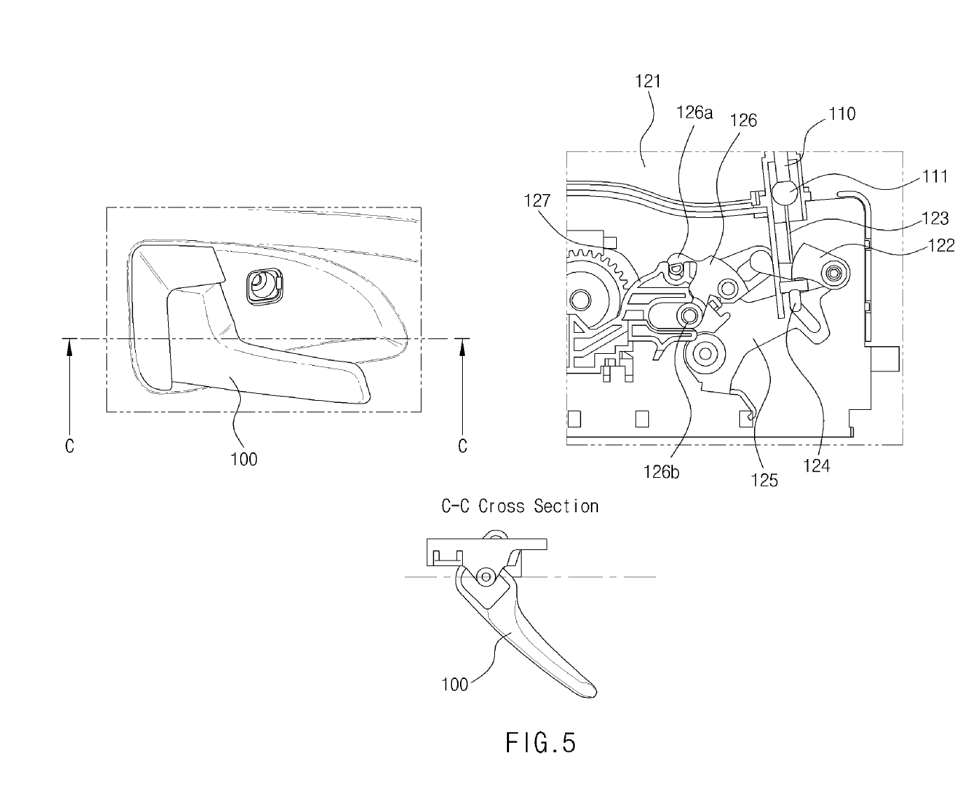

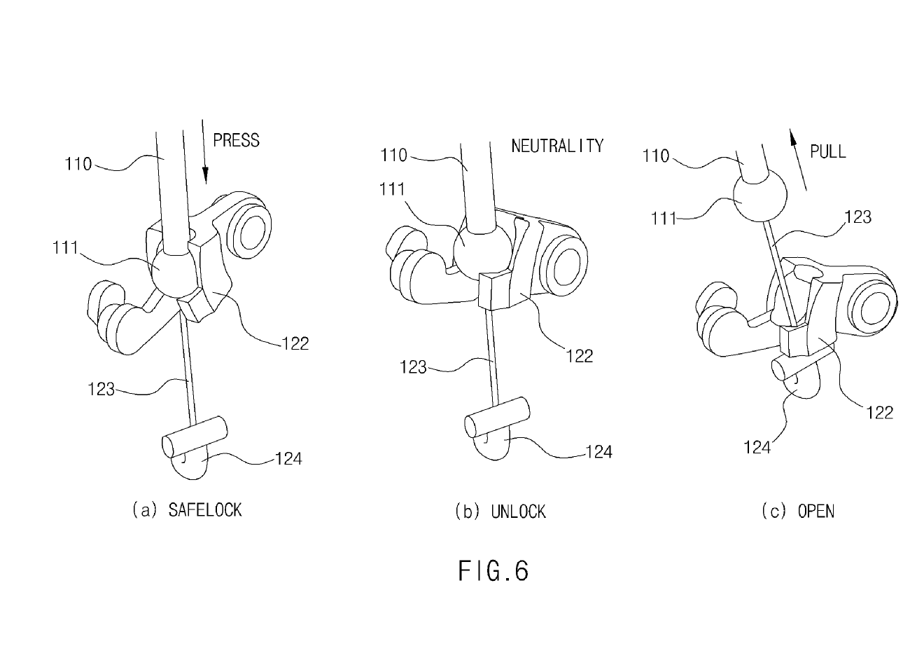

FIG. 3 illustrates the operation of each component at the time of performing the door lock operation in accordance with an embodiment of the present invention. FIG. 4 illustrates the operation of each component at the time of performing the door unlock operation in accordance with an embodiment of the present invention. FIG. 5 illustrates the operation of each component at the time of performing the door open operation in accordance with an embodiment of the present invention. FIG. 6 illustrates the operation of a safety lock link at the time of performing each door operation in accordance with an embodiment of the present invention.

1. Door Safety Lock

The integrated lever 100 is pushed away from the passenger compartment, thereby keeping the door latch assembly locked through the cable 110.

Here, when the integrated lever 100 is pushed, the end of the cable moves downwards, and thus the ball end 111 of the end of the cable pushes and rotates the ball socket 122a of the first link 122. Thereby, the ball end 111 is surrounded by the ball socket 122a, so that the door is put into a safety locked state.

At this time, the second link 126 is rotated in a direction opposite the direction where the first link 122 is rotated, thereby pulling the third link 127 in a rightward direction. The slide part 126b of the second link 126 moves into the slide groove of the third link 127, and the hook 124 connected with the end of the cable moves toward the lower end of the hooking slot.

Here, the fourth link 125 is rotated in a downward direction, and the user feels the operation caused by the coupling of the ball end 111 with the ball socket 122a. When the integrated lever 100 is pulled with force enough to decouple the ball end 111 from the ball socket 122a, the safety lock of the door can be released.

Accordingly, the integrated lever 100 is allowed to perform the function of the safety lock knob.

2. Door Unlock

The integrated lever 100 is put in a neutral state, thereby keeping the door latch assembly unlocked through the cable 110.

Here, when the integrated lever 100 is put in the neutral state, the end of the cable is pulled, and thus the ball end 111 of the end of the cable pulls up and rotates the first link 122. Thereby, the ball end 111 comes out of the ball socket 122a, so that the door is put in an unlocked state. As the first link 122 is rotated and returns to its original state, the second link 126 is rotated in a direction opposite the direction where the first link 122 is rotated, thereby pushing the third link 127 in a leftward direction. The slide part 126b of the second link 126 moves out of the slide groove of the third link 127.

The hook 124 connected with the end of the cable moves toward the upper end of the hooking slot.

3. Door Open

The integrated lever 100 is pulled from the passenger compartment, thereby keeping the door latch assembly opened thanks to the cable 110.

Here, when the integrated lever 100 is pulled, the end of the cable moves upwards, and thus the ball end 111 of the end of the cable is completely decoupled from the ball socket 122a of the first link 122 in an upward direction. As the hook 124 connected with the end of the cable pulls up and rotates the fourth link 125, the door is put in an open state.

Here, the first, second and third links 122, 126 and 127 take part in the lock/unlock operation of the door, whereas the first link 122 and the fourth link 125 take part in the open operation of the door.

For convenience in explanation and accurate definition in the appended claims, the terms “upper” or “lower”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle door locking system comprising:
a door latch assembly installed on one side of a door;
an integrated lever operating the door latch assembly; and
a cable connecting the integrated lever with the door latch assembly,
wherein the door is put in an open state when the integrated lever is pulled, in an unlocked state when the integrated lever is in a neutral state, and in a safety locked state when the integrated lever is pushed.

2. The vehicle door locking system of claim 1, wherein the door latch assembly comprises:
a housing;
a latch release link rotatably installed in the housing; and
an actuator connected to an end of the cable for rotating the latch release link to keep the door locked or unlocked.

3. The vehicle door locking system of claim 2, wherein the actuator comprises a hooking slot formed in one end of the latch release link, a hook sliding up and down along the hooking slot when the door is unlocked or locked, and a connecting cable connecting the cable with the hook.

4. The vehicle door locking system of claim 2, further comprising:
a ball end formed at the end of the cable so as to move up and down;
a safety lock link rotatably installed at an upper portion of the latch release link; and
a ball socket recessed in the safety lock link so as to be coupled with the ball end when the ball end moves down.

5. The vehicle door locking system of claim 4, wherein the housing comprises a guide protrusion guiding upward and downward movements of the ball end.
